(19) United States
(12) Patent Application Publication
(10) Pub. No.: US 2007/0098250 A1
(43) Pub. Date: May 3, 2007

(54) Man-machine interface based on 3-D positions of the human body

(75) Inventors: John Molgaard, Sortemosen (DK); Stefan Penter, Fyrrevang (DK); Hans Kyster, Bringetoften (DK)

Correspondence Address: VOLENTINE FRANCOS, & WHITT PLLC, ONE FREEDOM SQUARE, 11951 FREEDOM DRIVE SUITE 1260, RESTON, VA, 20190, US

(73) Assignee: DELTA DANSK ELEKTRONIK, LYS OG AKUSTIK, DK-2970 HORSHOLM (DK)

(21) Appl. No.: 10/555,342

(22) PCT Filed: Apr. 30, 2004
(86) PCT No.: PCT/DK04/00298

§ 371 Date: Jan. 3, 2007

(30) Foreign Application Priority Data
May 1, 2003 (DK) PA 2003 00660

(51) Int. Cl. G06K 9/00; G06T 15/00; G06F 3/00

(52) U.S. Cl. 382/154; 345/419; 715/863

(57) ABSTRACT

The invention relates to a man-machine interface wherein three-dimensional positions of parts of the body of a user is detected and used as an input to a computer. An electronic system is provide for determining three-dimensional positions within a measuring volume, comprising at least one electronic camera for recording of at least two images with different viewing angles of the measuring volume, and an electronic processor that is adapted for real-time processing of the at least two images for determination of three-dimensional positions in the measuring volume of selected objects in the images.

### FIELD OF THE INVENTION

The invention relates to a man-machine interface wherein three-imensional positions of parts of the body of a user is detected and used as an input to a computer.

### BACKGROUND OF THE INVENTION

In US 2002/0036617, a method and an apparatus is disclosed for inputting position, attitude (orientation) or other object characteristic data to computers for the purpose of Computer Aided learning, Teaching, Gaming, Toys, Simulations, Aids to the disabled, Word Processing and other applications. Preferred embodiments utilize electro-optical sensors, and particularly TV cameras for provision of optically inputted data from specialized datum's on objects and/or natural features of objects. Objects can be both static and in motion from which individual datum positions and movements can be derived also with respect to other objects both fixed and moving.

### SUMMARY OF THE INVENTION

According to the present invention, an electronic system is provided for determining three-dimensional positions within a measuring volume, comprising at least one electronic camera for recording of at least two images with different viewing angles of the measuring volume, and an electronic processor that is adapted for real-time processing of the at least two images for determination of three-dimensional positions in the measuring volume of selected objects in the images.

In a preferred embodiment of the invention, the electronic system comprises one electronic camera for recording images of the measuring volume, and an optical system positioned in front of the camera for interaction with light from the measuring volume in such a way that the at least two images with different viewing angles of the measuring volume are formed in the camera.

Positions of points in the measurement volume may be determined by simple geometrical calculations, such as by triangulation.

The optical system may comprise optical elements for reflection, deflection, refraction or diffraction of light from the measurement volume for formation of the at least two images of the measurement volume in the camera. The optical elements may comprise mirrors, lenses, prisms, diffractive optical elements, such as holographic optical elements, etc, for formation of the at least two images.

Preferably, the optical system comprises one or more mirrors for deflection of light from the measurement volume for formation of the at least two images of the measurement volume in the camera.

Recording of the at least two images with a single camera has the advantages that the images are recorded simultaneously so that further synchronization of image recording is not needed. Further, since recordings are performed with the same optical system, the images are subjected to substantially identical color deviations, optical distortion, etc, so that, substantially, mutual compensation of the images is not needed.

In a preferred embodiment of the invention, the optical system is symmetrical about a symmetry plane, and the optical axis of the camera substantially coincides with the symmetry plane so that all characteristics of the images are substantially identical substantially eliminating a need for subsequent matching of the images.

In a preferred embodiment of the invention, the system is calibrated so that image forming distortions of the camera may be compensated whereby a low cost digital camera, e.g. a web camera, may be incorporated in the system, since after calibration, the images of the camera can be used for accurate determinations of three-dimensional positions in the measurement volume although the camera itself provides images with significant geometrical distortion. For example today's web cameras exhibit app. 10-12% distortion. After calibration, the accuracy of positions determined by the present system utilizing a low cost web camera with 640*480 pixels is app. 1%. Accuracy is a function of pixel resolution.

Preferably, calibration is performed by illuminating a screen by a projector with good quality optics displaying a known calibration pattern, i.e. comprising a set of points with well-known three-dimensional positions on the screen.

For example in an embodiment with one camera and an optical system for formation of stereo images in the camera, each point in the measurement volume lies on two intersecting line of sights, each of which intersects a respective one of the images of the camera at a specific pixel. Camera distortion, tilt, skew, etc, displace the line of sight to another pixel than the “ideal” pixel, i.e. the intersected pixel without camera distortion and inaccurate camera position and orientation. Based on the calibration and the actual intersected pixel, the “ideal” pixel is calculated, e.g. by table look-up, and accurate line of sights for each pixel in each of the images are calculated, and the three-dimensional position of the point in question is calculated by triangulation of the calculated line of sights.

The processor may further be adapted for recognizing predetermined objects, such as body parts of a human body, for example for determining three-dimensional positions of body parts in relation to each other, e.g. by determining human body joint angles.

In a preferred embodiment of the present invention colors are recognized by table look-up, the table entries being color values of a color space, such as RGB-values, or corresponding values of another color space, such as the CIE 1976 L*a*b* color space, the CIE 1976 L*u*v* color space, the CIELCH (L*C*h^{o}) color space, etc.

8 bit RGB values create a 24 bit entry word, and with a one bit output value, the table will be a 16 Mbit table, which is adequate with present day's computers. The output values may be one if the entry value indicates the color to be detected, and zero if not.

Skin color detection may be used for detection of positions of a user's head, hands, and eventual other exposed parts of the body. Further, the user may wear patches of specific colors and/or shapes that allow identification of a specific patch and three-dimensional position determination of the patch.

The user may wear retro-reflective objects to be identified by the system and their three-dimensional position may be determined by the system.

The positions and orientations of parts of a user's body may be used as input data to a computer, e.g. as a substitution for or a supplement to the well-known keyboard and mouse/trackball/joystick computer interface. For example, the execution of a computer game may be made dependent on user body positioning and movement making the game perception more “real”. Positions and orientations of bodies of more than one user may also be detected by the system according to the present invention and used as input data to a computer, e.g. for interaction in a computer game, or, for co-operation e.g. in computer simulations of e.g. space craft missions, etc.

Positions and orientations of parts of a user's body may also be used as input data to a computer monitoring a user performing certain exercises, for example physical rehabilitation after acquired brain damage, a patient re-training after surgery, an athlete training for an athletic meeting, etc. The recorded positions and orientations may be compared with desired positions and orientations and feedback may be provided to the user signaling his or her performance. Required improvements may be suggested by the system. For example, physiotherapeutic parameters may be calculated by the system based on determined positions of specific parts of the body of the user.

Feedback may be provided as sounds and/or images.

Three-dimensional positions are determined in real time, i.e. a user of the system perceives immediate response by the system to movement of his or her body. For example, positions of 13 points of the body may be determined 25 times pr. second.

Preferably, three-dimensional position determination and related calculations of body positions and orientations are performed once for each video frame of camera, i.e. 60 times pr. second with today's video cameras.

### BRIEF DESCRIPTION OF THE DRAWINGS

In the following, exemplary embodiments of the invention will be further explained with reference to the drawing wherein:

FIG. 1 illustrates schematically a man-machine interface according to the present invention,

FIG. 2 illustrates schematically a sensor system according to the present invention,

FIG. 3 illustrates schematically a calibration set-up for the system according to the present invention,

FIG. 4 illustrates the functions of various parts of a system according to the present invention,

FIG. 5 illustrates schematically an image feature extraction process,

FIG. 6 illustrates schematically 3D acquisition, and

FIG. 7 illustrates schematically a 3D tracking process.

### DETAILED DESCRIPTION OF PREFERRED EMBODIMENTS

In many systems the interaction between a human operator or user and a computer is central. The present invention relates to such a system, where the user interface comprises a 3D imaging system facilitating monitoring e.g. the movements of the user or other objects in real time.

It is known that it is possible to obtain stereo images with one camera and an optical system in front of the lens of the camera. For example, the optical system may form a pair of images in the camera with different viewing angles, thus forming stereoscopic images. The different viewing angles of the two images provide information about the distance from the camera of points that appear in both images. The distance may be determined geometrically, e.g. by triangulation. The accuracy of the distance determination depends on the focal length of the camera lens, the distance between the apparent focal points created by the optical system in front of the camera, and also on the geometric distortion created by tilt, skew, etc, of the camera, the lens of the camera and the optical system in front of it and the image sensor in the camera.

Typically, the image sensor is an integrated circuit, which is produced using precise lithographical methods. Typically, the sensor comprises an array of light sensitive cells so-called pixels, e.g. an array of 640*480 pixels. As a result of the lithographic process, the array is very uniform and the position of each pixel is accurately controlled. The position uncertainty is kept below a fraction of a pixel. This means that the geometrical distortion in the system according to the invention is mainly generated by the optical components of the system.

It is well known how to compensate geometric distortion by calibration of a lens based on a few images taken with a known static image pattern placed in different parts of the scene. The result of this calibration is an estimate of key optical parameters of the system that are incorporated in formulas used for calculations of positions taking the geometrical distortion of the system into account. The parameters are typically the focal length and coefficients in a polynomial approximation that transforms a plane into another plane. Such a method may be applied to each image of the present system.

It is however preferred to apply a novel and inventive calibration method to the system. Assume that an image is generated wherein the physical position of each pixel is known and each pixel is like a lighthouse emitting its position in a code. If such an image were placed in front of the camera of the present system covering the measurement volume then each pixel in the camera would receive information, which could be used to calculate the actual line of sight. The advantage of this approach is that as long as the focal point of the camera lens can be considered a point, then complete compensation for the geometric distortion is possible. So a low cost camera with a typical geometrical distortion of the lens and the optical system positioned in front of the camera of e.g. 12% may be calibrated to obtain an accuracy of the system that is determined by the accuracy of the sensor in the camera.

The advantage of using a single camera to obtain stereo images is that the images are captured simultaneously and with the same focal length of the lens, as well as the same spectral response, gain and most other parameters of the camera. The interfacing is simple and no synchronisation of more cameras is required. Since the picture is effectively split up in two by the optical system in front of the camera the viewing angle is halved. A system with a single camera will make many interesting applications feasible, both due to the low cost of the camera system and the substantially eliminated image matching requirements. It is expected that, in the future, both the resolution of PC cameras and the PC processing power will steadily increase over time further increasing the performance of the present system.

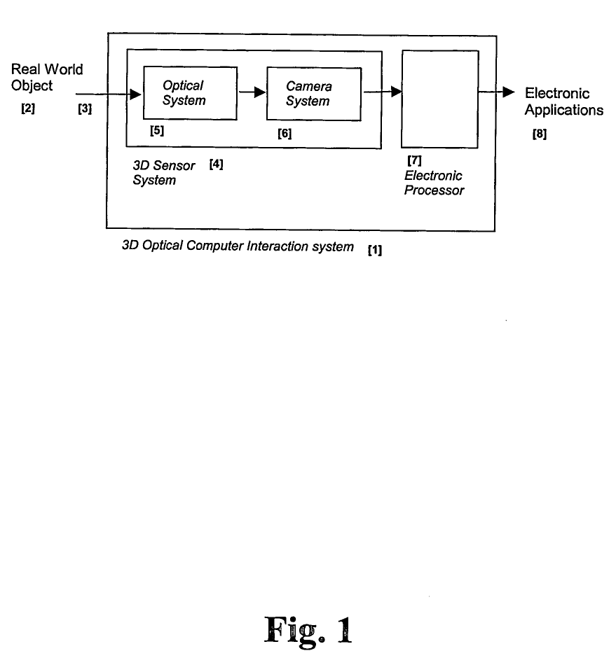

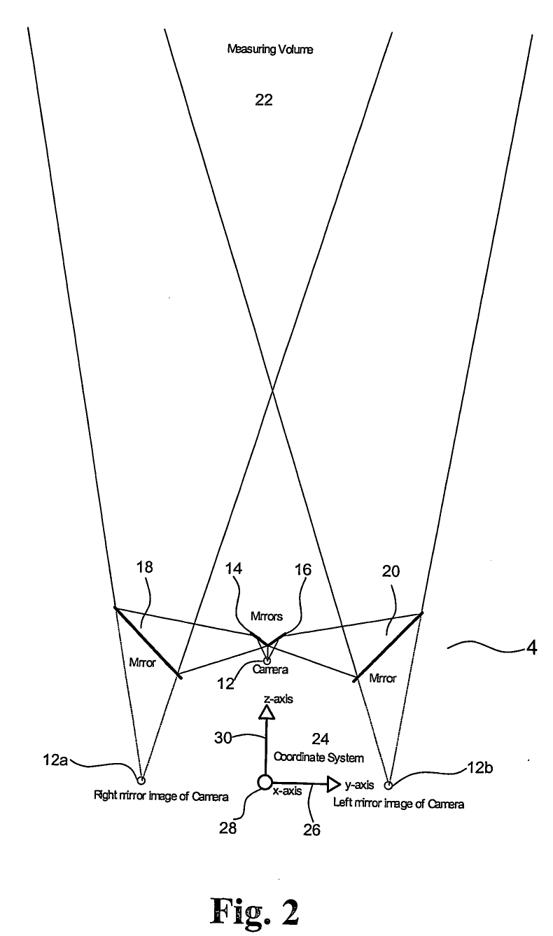

FIG. 1 illustrates schematically an embodiment of a man-machine interface 1 according to the present invention. The system 1 comprises three main components: an optical system 5, a camera 6 and an electronic processor 7. The optical system 5 and the camera 6 in combination are also denoted the sensor system 4.

During operation of the system 1, objects 2 in the measurement volume, such as persons or props, are detected by the sensor system 4. The electronic processor 7 processes the captured images of the objects 2 and maps them to a simple 3D hierarchical model of the ‘Real World Object’ 2 from which 3D model data (like angles between joints in a person, or x, y, z-position and rotations of joints) are extracted and can be used by electronic applications 8 e.g. for Computer Control.

FIG. 2 illustrates one embodiment the sensor system 4 comprising a web cam 12 and four mirrors 14, 16, 18, 20. The four mirrors 14, 16, 18, 20 and the web cam 12 lens create two images of the measurement volume at the web cam sensor so that three-dimensional positions of points in the measurement volume 22 may be determined by triangulation. The large mirrors 18, 20 are positioned substantially perpendicular to each other. The camera 12 is positioned so that its optical axis is horizontal, and in the three-dimensional coordinate system 24, the y-axis 26 is horizontal and parallel to a horizontal row of pixels in the web cam sensor, the x-axis 28 is vertical and parallel to a vertical column of pixels in the web cam sensor, and the z-axis points 30 in the direction of the measurement volume. The position of the centre of the coordinate system is arbitrary. Preferably, the sensor system 4 is symmetrical around a vertical and a horizontal plane.

In another embodiment of the invention, real cameras may substitute the virtual cameras 12a, 12b, i.e. the mirrored images 12a, 12b of the camera 12.

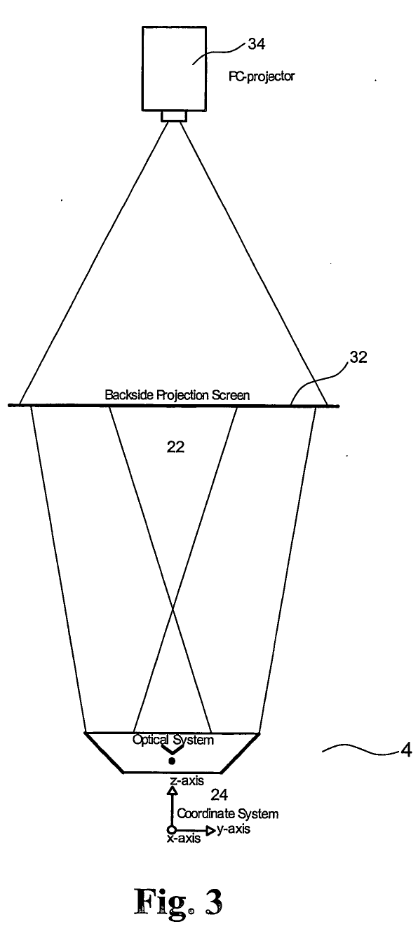

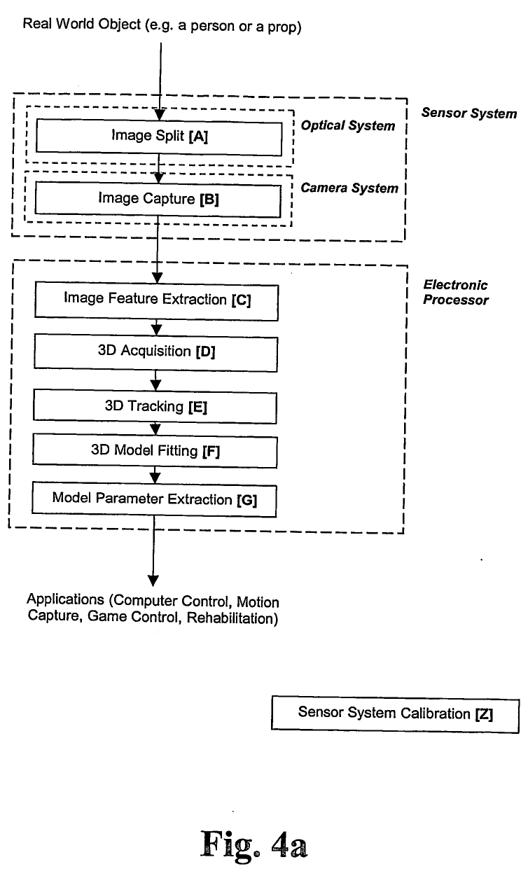

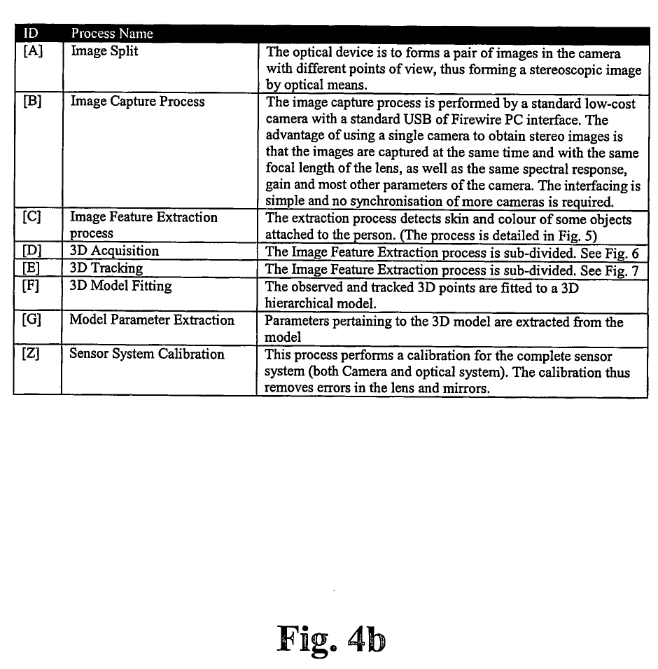

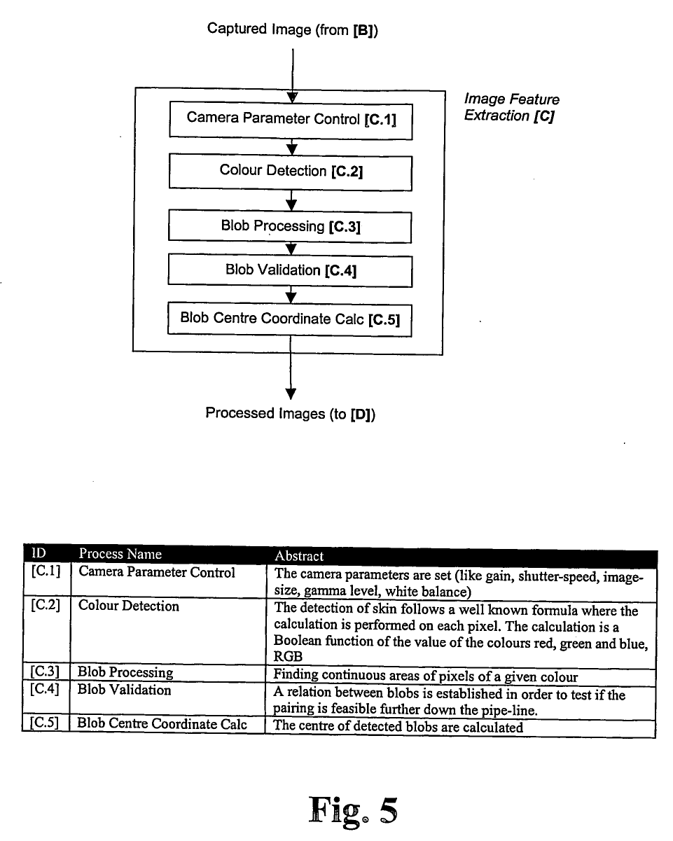

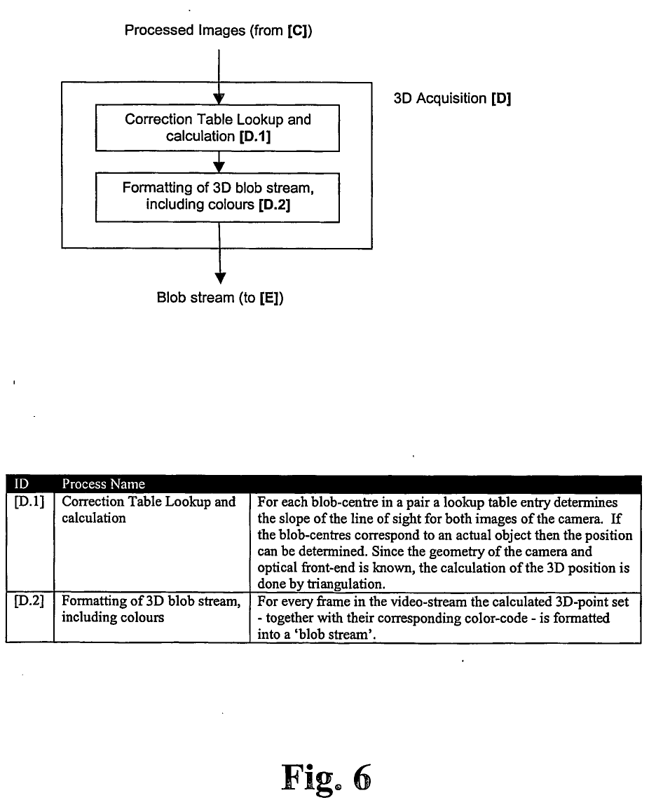

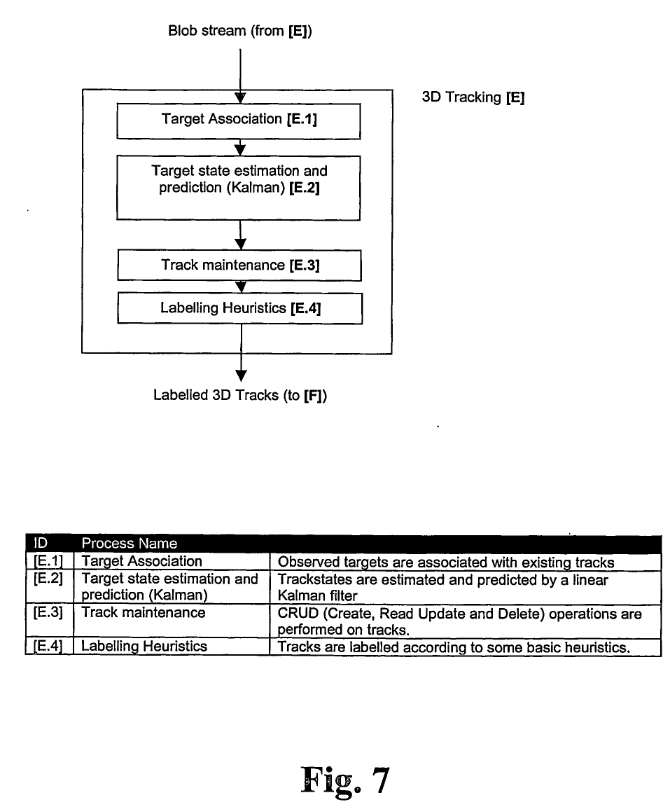

As illustrated in FIG. 3, during calibration, a vertical screen 32 is positioned in front of the sensor system 4 in the measurement volume 22 substantially perpendicular to the optical axis of the web cam 12, and a projector 34 generates a calibration image with known geometries on the screen. Position determinations of specific points in the calibration image are made by the system at two different distances of the screen from the camera whereby the geometrical parameters of the system may be determined. Based on the calibration, the lines of sight for each pixel of each of the images are determined, and e.g. the slopes of the line of sights are stored in a table. The position of a point P in the measurement volume is determined by triangulation of the respective line of sights. In general, the two lines of sights will not intersect in space because of the quantisation of the image into a finite number of pixels. However, they will get very close to each other, and the distance between the lines of sights will have a minimum at the point P. If this minimum distance is less than a threshold determined by the quantisation as determined by the pixel resolution, the coordinates of P is determined as the point of minimum distance between the respective line of sights.

Preferably, a projector generates the calibration image with at least ten times less geometrical distortion than the system.

In a preferred embodiment of the invention, the calibration image is a black and white image, and more preferred the calibration image comprises one black section and one white section preferably divided by a horizontal borderline or a vertical borderline.

The calibration method may comprise sequentially projecting a set of calibration images onto the screen for example starting with a black and white calibration image with a horizontal borderline at the top, and sequentially projecting calibration images moving the borderline downwards a fixed number of calibration image pixels, e.g. by 1 calibration image pixel.

Each camera pixel is assigned a count value that is stored in an array in a processor. For each calibration image displayed on the screen the pixel count value is incremented by one if the corresponding camera pixel “views” a black screen. During calibration an image of the borderline sweeps the camera sensor pixels, and after completion of a sweep, the count values contain the required information of which part of the screen is imaged onto which camera pixels.

This procedure is repeated with a set of black and white calibration images with a vertical borderline that is swept across the screen, and a second pixel count value is assigned to each camera pixel that is stored in a second array in the processor. Again for each calibration image displayed on the screen the second pixel count value is incremented by one if the corresponding camera pixel “views” a black screen.

Thus, one sweep is used for calibration of the x-component and the other sweep is used for calibration of the y-component so that the x- and y-component are calibrated independently.

Before translating the first and second count values into corresponding line of sights for each camera pixel, it is preferred to process the count values. For example, anomalies may occur caused, e.g. by malfunctioning projector pixels or camera pixels or by dust on optical parts. A filter may detect deviations of the count values from a smooth count value surface, and for example a pixel count value deviating more than 50% from its neighbouring pixel count values may be substituted by an average of surrounding pixel count values.

Further, at the edges of the camera sensor, the corresponding array of count values may be extended beyond the camera sensor by smooth extrapolation of pixel count values at the sensor edge whereby a smoothing operation on the count values for all sensor pixels is made possible.

A smoothing operation of the count values may be performed, e.g. by spatial low-pass filtering of the count values, e.g. by calculation of a moving average of a 51*51 pixel square. The size of the smoothing filter window, e.g. the averaging square, is dependent on the geometrical distortion of the sensor system. The less distortion, the smaller the filter window may be.

Preferably, the low-pass filtering is repeated twice.

Preferably, the extended count values for virtual pixels created beyond the camera sensor are removed upon smoothing.

The calibration procedure is repeated for two distances between the system and the screen so that the optical axes of the cameras or the virtual, e.g. mirrored, cameras shown in FIG. 2 may be determined. It should be noted that the images in the (virtual) cameras of the respective intersections of the optical axes with the screen does not move relative to the camera sensor upon displacement along the z-axis of the system in relation to the screen. Thus, upon displacement, the two unchanged pixels are determined whereby the optical axes of the (virtual) cameras are determined. The position of the optical centre of each (virtual) camera is determined by calculation of intersections of line of sights from calibration image pixels equidistantly surrounding the intersection of the respective optical axis with the screen. An average of calculated intersections may be formed to constitute the z-value of the optical centre of the (virtual) camera in question.

Knowing the 3D-position of the optical centre of the (virtual) cameras, the line of sights of each of the camera pixels may be determined.

In the illustrated embodiment, the optical axis of the camera is horizontal. However, in certain applications, it may be advantageous to incline the optical axis with respect to a horizontal direction, and position the system at a high position above floor level. Hereby, the measurement volume of the system may cover a larger area of the floor or ground. For example, the optical axis of the camera (and the system) may be inclined 23°.

It is relatively easy to adjust the tables to this tilt of the x-axis of the system.

Preferably, the y-axis remains horizontal.

There are many ways to extract features from a pair of stereo images, this effect how the image is processed. For example, if it is desired to detect major movements of a single person in the field of view, detection of the skin and the colour of some objects attached to the person may be performed [C]. The person may be equipped with a set of colours attached to the major joints of the body. By determining at each instance the position of these features (skin and colours) for example 13 points may be obtained in each part of the stereo image. The detection of skin follows a well-known formula where the calculation is performed on each pixel, cf. D. A. Forsyth and M. M. Fleck: “Automatic detection of human nudes”, Kluwer Academic Publishers, Boston. The calculation is a Boolean function of the value of the colours red, green and blue, RGB [C.2]. The same calculation for detection of skin may be used for detection of colours, however, with other parameters.

Thus, for each feature a picture of truth-values is obtained, the feature exists or not for each pixel. Since the objects of interest, skin and colours, normally have a certain size, areas of connected pixels are identified with the same truth-value for each feature, called blobs [C.3]. The position of the centre of each blob is calculated [C.5]. For determination of the 3D position of each object, the blobs should come in pairs, one blob in each of the stereo images. A relation between blobs is established in order to test if the pairing is feasible [C.4]. The pairing is feasible if there is a corresponding blob in the other stereo image within a certain distance from the original blob. If the pairing is feasible in both directions, it is assumed that the blobs belong to an object and the position of the pair of blobs is used to determine the position in 3D by triangulation.

The calculation of the 3D position assumes that the geometry of the camera and optical front-end is known [D].

The basis for the triangulation is the distance between the optical centres of the mirror images of the camera. If a point is seen in both parts of the stereo image the position relative to the camera setup can be calculated, since the angles of the rays between the point and the optical centres are obtained from the pixels seeing the point. If the camera is ideal, i.e. there is no geometrical distortion then the angles for each pixel relative to the optical axis of each of mirror images of the camera can be determined by the geometry of the optical front-end system, i.e. in the case of mirrors by determining the apparent position and orientation of the camera. While it is not necessary for the functioning of such a system to position the mirror images on a horizontal line, this is often done, since it seams more natural to human beings to orient the system in the way it is viewed. If the camera is ideal, the above calculation can be done for each pair of blobs, but it is more efficient in a real time application to have one or more tables and look up values, that can be calculated on beforehand [D.1]. If the tables were organised as if two ideal cameras are present, with the optical axis normal to the line between the two optical centres, this would further simplify the calculations, since the value of the tangent function of the angle, which is required in the calculation, could be placed in the table instead of the actual angle.

So in principle 13 points in 3D are now obtained related to the set of colours of the objects. In practice the number of points can be differing from 13, since objects can be obscured from being seen in both images of the stereo pair. Also background objects and illumination can contribute to more objects, i.e. an object representing the face is split in two blobs due to the use of spectacles, a big smile or beard. This can also happen if the colours chosen are not discriminated well enough. This means that it is necessary consolidate the blobs. Blobs belonging to objects in the background can be avoided by controlling the background colours and illumination, or sorted out by estimating and subtracting the background in the images before the blobs are calculated, or the blobs can be disregarded since they are out of the volume where the person is moving.

In order to consolidate the 3D points tracking [E] is used, blobs are formatted [D.2] and send to a tracker. This is a similar task to tracking the planes on radar in a flight control centre. The movements of points are observed over time.

This is done by linear Kalman filtering and consists of target state estimation and prediction.

Hypothesis of points in time belonging to the same track is formed and if the hypothesis is consistent with other knowledge, then the track may be labelled [E.4]. It is known that the movements of a person are tracked represented by 13 objects.

If all of the objects had a different colour, then it would be simple to label the targets found, since each colour would correspond to a joint in the model of the person. There are too few colours to discriminate and also the colour of the skin of the hands and the head is similar. For each joint it is known what colour to expect. With that knowledge and also knowledge of the likely movements of the person, some heuristics may be formulated that can be used for target association [E.1], and/or labelling [E.4]. If, for example, the left ankle, the right hip and right shoulder have the same colour, and it is known that the person is standing or sitting. Then the heuristic could be that the shoulder is above the hip and the hip is above the angle. When the situation occurs that exactly three targets are satisfying that heuristic then, the targets are labelled accordingly.

A model of a person described by 13 points in 3D is now provided, i.e. the positions are known of all the major joints of the person in absolute coordinates relative to the optical system. If the position and orientation of the optical system is known, then these positions can be transformed to say the coordinates of the room. So it is known at each instance where the person is in the room and the pose of the person—if the person is seen in both parts of the stereo image and the pose are within our assumed heuristics. There are many possible uses for such a system; but often it is of interest to know the movements relative to the person, independent of where the person is situated in the room. In order to achieve this independence of the position an avatar is fitted to the above model of the person [F]. An avatar is a hierarchical data structure, representing a person. In our case the avatar is simplified to a skeleton exhibiting the above 13 major joints. Each joint can have up to 3 possible axes of rotation. The root of the hierarchal structure is the pelvis. The position and orientation of the pelvis is measured in absolute coordinates relative to the camera system. The angles of rotation and the length of the bones of the skeleton determine all the positions of the 13 joints. Since the bones are fixed for a given person the pose of the person is determined by the angles of the joints. Unfortunately the function from pose to angles is not monotonic, a set of angles uniquely determines one pose; but one pose does not have a unique set of angles. So unless suitably restricted the angles cannot be used as a measure of the pose. To overcome this problem, an observation system is added [G]; such that the angles observed exhibits the required monotony. Since not all joints have 3 degrees of freedom there is not provided 39 measures for angles, but only 31. Using these angles and the position and orientation of the pelvis, the pose of the person may be determined at any given instant.

An application of such a system can for example be to analyse the movements of a handicapped person performing an exercise for rehabilitation purposes. If an expert system is used, the movements may be compared to predetermined exercises or gestures. The expert system could be based on a neural network, which is trained to recognise the relevant exercise or gesture. A different approach is preferred using physiotherapeutic knowledge to which of the angles will vary for a correct exercise and which should be invariant. The advantage of this approach is mainly that it is much faster to design an exercise than to obtain the training data for the neural network by measuring and evaluating a given exercise for e.g. 100 or more different persons.

The variations of the angles during an exercise can be used to provide feedback to the person doing the exercise both at the moment a wrong movement is detected and if the exercise is executed well. The feedback can be provided by sounds, music or visually. One could imagine that the movements in the exercise are used to control a computer game, in such a way that the movements of the person are controlling the actions in the game, mapping the specific movements to be trained to the controls.

The above-mentioned system may be used as a new human computer interface, HCI, in general. The detailed mapping of the movements to the controls required depends on the application. If the system is used to control say, a game, the mapping most likely should be as natural as possible, for instance to perform a kick or a jump would give the same action in the game. To point at something pointing with the hand and the arm could be used, but it is also possible to include other physical objects in the scene, e.g. a coloured wand and use this for pointing purposes. The triggering of an action, when pointing at something can be done by movement of another body part or simply by a spoken command.

While the present system requires even illumination and special patches of colour in the clothing, it is known how to alleviate these requirements. For example using the 3d information more extensively to make depth maps and volume fitting of the parts of the body of the avatar. Or using an avatar, which is much more detailed similar to the person in question with skin and clothing and the fitting views of that avatar from two virtual cameras positioned in the same way relative to the avatar as the person to the two mirror images of the real camera. The pose of the avatar is then manipulated to obtain the best correlation of the virtual pictures to the real pictures. The above descriptions use spatial information but the use of temporal information just as relevant. For example assuming that the camera is stationary the variation in intensity and colour from the previous picture for a given pixel is representing either a movement or an illumination change, this can be used to discriminate the person from the background, building up an estimate of the background picture. Also detecting the movements reduces the processing required, since any object not moving can be assumed to be at the previous determined position. So instead of examining the whole picture for features representing objects, the search may be limited to the areas where motion is detected.

1. An electronic system for determining three-dimensional positions within a measuring volume, comprising
at least one electronic camera for recording of at least two images with different viewing angles of the measuring volume,
an electronic processor that is adapted for real-time processing of the at least two images for determination of three-dimensional positions in the measuring volume of selected objects in the images.

2. An electronic system according to claim 1, comprising one electronic camera for recording images of the measuring volume, and an optical system positioned in front of the camera for interaction with light from the measuring volume in such a way that the at least two images with different viewing angles of the measuring volume are formed in the camera.

3. An electronic system according to claim 1, wherein the processor is further adapted for recognizing predetermined objects.

4. An electronic system according to claim 3, wherein the processor is further adapted for recognizing body parts of a human body.

5. An electronic system according to claim 4, wherein three-dimensional positions of body parts are used for computer control.

6. An electronic system according to claim 4, wherein three-dimensional movements of body parts are used for computer control.

7. An electronic system according to claim 1, wherein the processor is further adapted for recognizing colour patches worn by a human object in the measuring volume.

8. An electronic system according to claim 1, wherein the processor is further adapted for recognizing retro-reflective objects worn by a human object in the measuring volume.

9. An electronic system according to claim 1, wherein the processor is further adapted for recognizing exposed parts of a human body by recognition of human skin.

10. An electronic system according to claim 1, wherein the processor is further adapted for recognizing colors by table lookup, the table entries being color values of a color space, such as RGB-values.

11. An electronic system according to claim 4, wherein the processor is further adapted for determining three-dimensional positions of body parts in relation to each other.

12. An electronic system according to claim 1 , wherein the processor is further adapted for determining human body joint angles.

13. An electronic system according to claim 4, wherein the processor is further adapted for determining performance parameters related to specific body positions.

14. An electronic system according to claim 13, wherein the processor is further adapted for determining performance parameters of specific human exercises.

15. An electronic system according to claim 14, wherein at least some of the performance parameters are physiotherapeutic parameters.

16. An electronic system according to claim 13, wherein the processor is further adapted for providing a specific output in response to the determined peilormance parameters.

17. An electronic system according to claim 16, further comprising a display for displaying a visual part of the output.

18. An electronic system according to claim 15, further comprising a sound transducer for emitting a sound part of the output.

19. An electronic system according to claim 1, wherein the optical system comprises mirrors for re-directing light from the measuring volume towards the camera.

20. An electronic system according to claim 1, wherein the optical system comprises prisms for re-directing light from the measuring volume towards the camera.

21. An electronic system according to claim 1, wherein the optical system comprises diffractive optical elements for re-directing light from the measuring volume towards the camera.

22. An electronic system according to claim 1, wherein the optical system is symmetrical about a symmetry plane and the optical axis of the camera substantially coincides with the symmetry plane.

23. A combined system comprising at least two systems according to claim 1, having overlapping measurement volumes.

24. A method of calibrating a system according to claim 1, comprising the steps of
positioning of a screen in the measuring volume of the system,
projecting a calibration image with known geometrical features onto the screen,
for specific calibration image pixels, determining the corresponding two image pixels in the camera, and
calculating the line of sight for substantially each pixel of the camera sensor.

25. A method according to claim 24, wherein the calibration image is generated by a projector with at least ten times less geometrical distortion than the system.

26. A method according to claim 24, wherein the calibration image is a black and white image.

27. A method according to claim 26, wherein the calibration image comprises one black section and one white section divided by a horizontal line.

28. A method according to claim 24, wherein the calibration image comprises one black section and one white section divided by a vertical line.

29. A method according to claim 24, wherein the step of projecting a calibration image comprises sequentially projecting a set of calibration images onto the screen.

30. A system for assessment of movement skills in a three-dimensional space, comprising an electronic system according to claim 1.

31. A computer interface utilizing three-dimensional movements, comprising an electronic system according to claim 1.

32. An interface to a computer game utilizing three-dimensional movements, comprising an electronic system according to claim 1.

33. A system for motion capture of three-dimensional movements, comprising an electronic system according to claim 1.
